(19) United States
(12) Patent Application Publication
(10) Pub. No.: US 2025/0122077 A1
(43) Pub. Date: Apr. 17, 2025

(54) PROCESS AND PLANT FOR PRODUCING A RAW SYNTHESIS GAS BY PARTIAL OXIDATION OF HYDROCARBON-CONTAINING GASES AND LIQUIDS

(71) Applicant: L'Air Liquide, Société Anonyme pour I'Etude et I'Exploitation des Procédés Georges Claude, Paris (FR)

(72) Inventors: Matthias MUELLER-HAGEDORN, Frankfurt am Main (DE); Karsten Covella, Frankfurt (DE); Gerald Botzen, Dusseldorf (DE)

(21) Appl. No.: 18/918,800

(22) Filed: Oct. 17, 2024

(30) Foreign Application Priority Data
Oct. 17, 2023 (EP) 23204062

(51) Int. Cl. C01B 3/36

(52) U.S. Cl. CPC C01B 3/36; C01B 2203/0255; C01B 2203/1258; C01B 2203/1276; C01B 2203/1288

(57) ABSTRACT

The invention relates to a process and a plant for producing a raw synthesis gas containing hydrogen and carbon oxides by simultaneous partial oxidation of a hydrocarbon-containing gas input stream and a hydrocarbon-containing liquid input stream containing impurities. The evaporation of the liquid input stream is carried out under partial evaporation conditions to obtain a gaseous mixed input stream and a liquid residual stream. The gaseous mixed input stream is depleted in the impurities relative to the hydrocarbon-containing liquid input stream and is fed into the partial oxidation, wherein the depletion efficaciously prevents the formation of deposits through crystallization of dissolved inorganic constituents or of carbon deposits, especially in and/or upstream of the POX burner. The liquid residual stream is enriched in the impurities relative to the hydrocarbon-containing liquid input stream and is discharged from the process.

### CROSS REFERENCE TO RELATED APPLICATIONS

This application claims the benefit of priority under 35 U.S.C. § 119 (a) and (b) to European Patent Application No. 23204062, filed Oct. 17, 2023, the entire con-tents of which are incorporated herein by reference.

### FIELD OF THE INVENTION

The invention relates to a process for producing a raw synthesis gas containing hydrogen and carbon oxides by simultaneous partial oxidation of a hydrocarbon-containing gas input stream and a hydrocarbon-containing liquid input stream. The invention further relates to a plant for producing a raw synthesis gas stream.

### PRIOR ART

Synthesis gases are gas mixtures containing hydrogen and carbon oxides which are used in various synthesis reactions. Examples thereof are methanol synthesis, the production of ammonia by the Haber-Bosch process or Fischer-Tropsch synthesis.

A commonly used process for producing synthesis gases is autothermal entrained flow gasification of gaseous, liquid or solid fuels, as described for example in DE 10 2006 059 149 B4. At the top of a reactor, an ignition and pilot burner is arranged centrally and three gasification burners are arranged with rotational symmetry to the reactor axis. Via the gasification burners, coal dust with oxygen and steam as gasification agents is supplied to a gasification space of the reactor in which the fuel is converted into synthesis gas. The hot gasification gas exits the gasification space together with the liquid slag and passes into a quench space into which water is injected for cooling of raw gas and slag. The slag is deposited in the water bath and is removed via a slag outflow. The quenched raw gas is withdrawn from the quench space in a steam-saturated state and purified in subsequent purification stages.

Since the fuel is reacted directly with the oxidant, the oxidant and the fuel must be supplied coaxially or coannularly.

U.S. Pat. No. 5,549,877 A1 also describes a process and an apparatus for producing synthesis gas, wherein an oxygen-containing oxidant is supplied centrally at the top of the reactor and, together with fuel supplied annularly around the oxidant feed, is introduced into the reaction space where the fuel is initially reacted substoichiometrically. A flame which spreads downwards into the reaction space is formed. In a recirculation zone, the materials present in the flame flow back in the upward direction. An additional stream of oxidant is supplied into the reaction zone downstream via an annular conduit, thus forming a more extended flame zone.

The partial oxidation (POX) of hydrocarbon-containing input material for producing synthesis gas is typically performed at high reactor temperatures in the range from 1000° C. to 1500° C. and pressures of up to 100 bara. The reactors used for non-catalytic partial oxidation (POX reactors) are often refractory lined reactors with hemispherical or virtually hemispherical domes. The partial oxidation burner (POX burner) is generally mounted at the top of the dome here.

The technical processes and apparatuses for partial oxidation known from the prior art propose various apparatuses for introducing and mixing the various streams, i.e. the hydrocarbon-containing input material, a generally oxygen-containing oxidant and sometimes a moderator. Moderators used are often carbon dioxide (CO₂) or steam, wherein the moderator is separately introduced into the reactor via a separate channel within the burner or admixed with one or more of the other input streams upstream of the burner. The oxidant employed is typically air, enriched air or pure oxygen (comprising at least 95 mol % of oxygen). A hydrocarbon-containing feed stream or input stream is a stream containing hydrocarbons such as methane, higher hydrocarbons or other hydrogen- and carbon-containing molecules (for example alcohols such as methanol, ethanol). This may also be a stream derived from an upstream primary reformer which contains not only carbon monoxide (CO), hydrogen (H₂), CO₂ and water (H₂O) but also hydrocarbons such as methane, ethane, ethylene or higher hydrocarbons such as benzene, toluene or xylenes. The mixing of the hydrocarbon-containing input material and the oxidant is generally carried out in a reactor in close proximity to the injection nozzles.

In the case of a gaseous hydrocarbon-containing input material (for example natural gas, steamcracker offgas, coke oven gas), the input material is mixed with a hydrogen-rich stream, preheated in one or more steps to 250° C. to 350° C. for example and passed into a hydrodesulfurization plant for removal of the sulfur components. Prior to an optional heating step for further temperature elevation to 350° C. to 550° C. for example, the desulfurized input material may be admixed with a moderator, for example steam or carbon dioxide. The hydrocarbon-containing mixture is subsequently introduced into a burner arranged at the upper end of the partial oxidation reactor. The burner is additionally supplied with oxygen and in some cases also a moderator. The various streams react within the refractory lined reactor at temperatures of for example 1000° C. to 1500° C. and typical pressures of for example 30 to 100 bar to afford a raw synthesis gas comprising hydrogen (H₂) and carbon monoxide (CO). The bottom of the reactor may be provided with an additional catalyst layer to facilitate the reactions. The gas exits the reactor and is cooled in a gas cooling unit capable of producing high pressure steam. The cooled synthesis gas is then freed of acidic gas constituents in the acid gas removal plant.

Some applications may also include an upstream CO shift stage to increase the hydrogen content. Customary processes for removing acidic gases include for example physisorptive or chemisorptive absorption processes or gas scrubbing processes, for example amine scrubbing processes or scrubbing with cryogenic methanol (Rectisol process). In some cases where no desulfurization is performed upstream of the partial oxidation reactor, sulfur components such as for example H₂S may also be removed in this stage. The purified synthesis gas is then conditioned to the desired H₂/CO ratio in a synthesis gas conditioning plant. Typical examples of synthesis gas conditioning steps are PSA, TSA, coldbox or membrane plants known per se from the literature. Other options for altering the synthesis gas composition include less complex methods such as admixing of pure H₂ or CO streams that are available in close proximity. Depending on the conditioning process, different product streams may be produced, for example a CO-rich stream and an H₂-rich stream.

Many chemical syntheses produce byproducts or contaminated solvents which are at present often only insufficiently recovered, for example by thermal recovery which releases CO₂. Partial oxidation is one option for converting these waste streams into valuable products, for example into H₂, CO or mixtures thereof, so that the carbon present therein can be recycled and converted into new products. However, the amount of the byproducts available in close proximity is generally too low for economic operation of a dedicated gasification plant. It is therefore desirable to admix different starting materials with the input stream of a POX plant. However, in many cases this is possible only with difficulty, if at all, on account of the type, composition or state of matter of the waste streams. Thus, for example a liquid waste stream containing inorganic elements cannot be injected into a hot gaseous feed stream of a POX plant since the evaporation residues form blockages or corrosion problems can occur on exposed materials. A further problem may be that the product is a complex mixture of different organic constituents which cannot be completely evaporated since they either have an excessively low vapour pressure under the given conditions or are thermally unstable and form carbon deposits at the injection site.

### SUMMARY

It is accordingly an object of the present invention to specify a process and a plant for producing a raw synthesis gas stream which can simultaneously process liquid and gaseous hydrocarbon-containing input streams but do not have the aforementioned disadvantages of the processes and plants from the prior art.

An oxygen-containing oxidant is to be understood as meaning any oxygen-containing fluid, for example pure oxygen in any desired purity, air or any other fluid capable of supplying oxygen to a carbon-containing reactant.

Partial evaporation conditions are to be understood as meaning the physicochemical/process engineering conditions which allow a liquid phase and the components present therein not to evaporate completely, i.e. to an extent of 100%, but rather for only a first proportion of the liquid phase to evaporate and for a second proportion of the liquid phase to remain as liquid and be discharged from the process, in one example discharged from the process as a residual stream. A person skilled in the art is capable of specifying these physicochemical/process engineering conditions as a result of their general knowledge in the art and/or to determine them through routine experiments.

A means is to be understood as meaning an article which makes it possible to achieve, or is helpful in achieving, an objective. Means for performing a particular process step are in particular to be understood as meaning all physical objects which a person skilled in the art would consider for performing this process step. For example, a person skilled in the art will consider means for introducing or discharging a material stream to include all transporting and conveying apparatuses, i.e. for example pipe conduits, pumps, compressors, valves, which seem necessary or sensible to said person skilled in the art for performing this process step on the basis of their knowledge of the art.

In the context of the present description, steam is to be understood as a synonym for water vapour unless the opposite is specified in the individual case. By contrast, the term “water” relates to water in the liquid state in the absence of indications to the contrary in the individual case.

If required, pressures are specified in absolute pressure units, bara or bar(a) for short, or in gauge pressure units, barg or bar(g) for short, in the absence of indications to the contrary in the individual case.

A fluid connection between two regions of the apparatus or plant according to the invention is to be understood as meaning any type of connection which makes it possible for a fluid, for example a gas stream, to be able to flow from the one to the other of the two regions, neglecting interposed regions or components. A direct fluid connection is especially to be understood as meaning any type of connection which makes it possible for a fluid, for example a gas stream, to flow directly from the one to the other of the two regions, with no further regions or components being interposed, with the exception of pure transportation operations and the means required therefor, for example pipe conduits, valves, pumps, compressors, reservoirs. One example would be a pipe conduit leading directly from the one to the other of the two regions.

Optionally or electively means that the subsequently described event or the conditions may occur or may not occur or that a feature may be present or may not be present. The description comprises cases in which the event or the condition occurs and cases in which it does not occur. The description likewise comprises cases in which a feature is present or is not present.

The conditions of non-catalytic partial oxidation (POX) or autothermal, catalytic partial oxidation (autothermal reforming, ATR) are known to a person skilled in the art from the prior art, for example the documents discussed at the outset. These are the physicochemical conditions under which a measurable, preferably an industrially relevant, conversion of fluid or fluidized carbon-containing input streams into synthesis gas products is achieved. These include as important parameters the establishment of a suitable partial oxidation temperature of typically about 1000° C. or above. It is especially characteristic of non-catalytic partial oxidation that no catalyst is present in the partial oxidation reactor.

Necessary adjustments of the conditions of the non-catalytic partial oxidation or the autothermal reforming to the respective operating requirements will be made by a person skilled in the art on the basis of routine experiments. Any specific reaction conditions disclosed may serve as a guide but should not be regarded as limiting in relation to the scope of the invention.

It is an objective of the present invention to recover liquid hydrocarbon streams, for example liquid, hydrocarbon-containing waste streams, in a POX process/in a POX plant which is operated with a gaseous input material, for example natural gas, steamcracker offgas, coke oven gas, as the primary input material. The POX process or POX plant may be operated either with an additional catalyst layer in the POX reactor (autothermal reformer, ATR) or in noncatalytic fashion (non-catalytic POX or gas POX). The invention describes a process and a plant for partial evaporation of an inflowing liquid input stream and for preventing deposits through crystallization of dissolved inorganic constituents or formation of carbon deposits, in particular in and/or upstream of the POX burner. Dissolved inorganic constituents may include for example inorganic metal ions of Na, K, Mg, Ca, Al, Si, Fe, Co, Cr, Mn, Zn, etc. or anions, for example phosphates, halides and others. Organic or inorganic sulfur compounds may likewise be present. In one example, primary constituents of the liquid input stream, for example of a liquid waste stream, are liquid hydrocarbons which in one example may also contain functional groups, for example alcohols, aldehydes, ketones, acids or ethers comprising heteroatoms such as oxygen, nitrogen and sulfur.

In one embodiment of the invention, a gaseous hydrocarbon input stream is preheated to a temperature of about 200° C. to 350° C. This is accomplished either through one or more heat exchangers, for example by heat exchange with steam and/or flue gas heat transfer media. In one example, a hydrogen-rich stream obtained from the produced raw synthesis gas and/or withdrawn from an external source is supplied to the hydrocarbon stream upstream of, between or downstream of the heat exchanger(s).

The preheated gaseous hydrocarbon stream is then divided into two substreams: In one example, one substream is passed directly to a hydrodesulfurization unit (HDS) while the other substream is passed to an evaporator unit. In the evaporator unit, the preheated, gaseous hydrocarbon stream is contacted with the liquid hydrocarbon input stream and provides the heat of evaporation. In addition, the hydrocarbons in the gaseous hydrocarbon stream reduce the partial pressure of the evaporated components of the liquid waste stream, thus reducing the tendency for interactions and undesired descendent reactions of components, for example polymerization or cracking reactions, in the partially evaporated liquid input stream. In an alternative example, the entire gaseous hydrocarbon stream is introduced into the hydrodesulfurization unit and divided into two substreams only downstream thereof, one substream being passed to an evaporator unit as a heat transfer medium and the other substream being directly supplied to the partial oxidation reactor.

It is essential to the invention that the evaporation of the liquid input stream in the evaporation apparatus is carried out under partial evaporation conditions, wherein the partial evaporation conditions are selected such that a gaseous mixed input stream and a liquid residual stream are discharged from the evaporation apparatus, wherein the gaseous mixed input stream is depleted in the impurities relative to the hydrocarbon-containing liquid input stream and wherein the liquid residual stream is enriched in the impurities relative to the hydrocarbon-containing liquid input stream. This affords a gaseous mixed input stream depleted in the impurities relative to the hydrocarbon-containing liquid input stream, so that the formation of deposits through crystallization of dissolved inorganic constituents or of carbon deposits, especially in and/or upstream of the POX burner, is efficaciously prevented.

In a second aspect of the invention, the process is characterized in that the second gas input substream stream is introduced into the partial oxidation reactor via the at least one partial oxidation burner and in that the gaseous mixed input stream is introduced into the partial oxidation reactor via the at least one partial oxidation burner and/or via a separate conduit. This provides increased flexibility in the feeding of input material to the POX process. When introducing the gaseous mixed input stream via a separate conduit, said conduit may be easily replaced and/or cleaned if required so that the POX burner is not impaired.

In a third aspect of the invention, the process is characterized in that the first average boiling point and the second average boiling point differ by at least 20° C., preferably by at least 50° C. Investigations have shown that for most impurities this ensures that said impurities remain in the liquid phase and are evaporated only to a small extent, if at all. This makes it possible to ensure trouble-free operation of the POX process over a longer period.

In a fourth aspect of the invention, the process is characterized in that the at least one impurity fraction comprises inorganic or organometallic constituents. Such constituents are found for example in cracker residue fractions and other hydrocarbon-containing, in particular crude oil-derived, liquid waste fractions, thus enabling material recovery thereof. The inorganic or organometallic constituents advantageously have a marked difference in boiling point relative to the hydrocarbons forming the primary constituents of the at least one impurity fraction so that the depletion of the latter in the inorganic or organometallic constituents by partial evaporation is easily possible.

In a fifth aspect of the invention, the process is characterized in that the at least one impurity fraction comprises inorganic constituents dissolved and/or suspended in the primary constituent fraction. In other words it is advantageous when the at least one impurity fraction does not form a separate phase since this facilitates the evaporation and mixing with the gaseous hydrocarbon stream.

In a sixth aspect of the invention, the process is characterized in that the inorganic constituents are present in ionic form, wherein preference is given to the presence of at least one cation selected from the group of: Na, K, Mg, Ca, Al, Si, Fe, Co, Cr, Mn, Zn, and/or wherein preference is given to the presence of at least one anion selected from the group of: phosphates, sulfates, chlorides, nitrates. These inorganic constituents present in ionic form advantageously have a marked difference in boiling point relative to the hydrocarbons forming the primary constituents of the at least one impurity fraction so that the depletion of the latter in the inorganic or organometallic constituents by partial evaporation is easily possible.

In a seventh aspect of the invention, the process is characterized in that the hydrocarbon-containing liquid input stream is admixed with a complexing agent which prevents or reduces crystallization of one or more of the ionic constituents. This allows the ionic constituents to be kept safely in the liquid phase, thus facilitating feeding thereof to the evaporation apparatus since no precipitation of solids occurs.

In an eighth aspect of the invention, the process is characterized in that the liquid residual waste stream is supplied to a process for recovery of metals. This allows material recovery of the metals present and the generation of problematic, partially toxic wastes can be prevented or at least reduced.

In a ninth aspect of the invention, the process is characterized in that the at least one impurity fraction comprises liquid hydrocarbons containing functional groups comprising heteroatoms such as oxygen, nitrogen and sulfur, preferably alcohols, aldehydes, ketones, acids or ethers. Such material fractions are problematic since their tendency for condensation and polymerization is particularly pronounced on account of the presence of the recited functional groups but is efficaciously reduced by the partial pressure reduction according to the invention.

In a tenth aspect of the invention, the process is characterized in that the at least one impurity fraction comprises polymerizable liquid hydrocarbons. Such material fractions are problematic since their tendency for polymerization is naturally particularly pronounced but is efficaciously reduced through the partial pressure reduction according to the invention.

In an eleventh aspect of the invention, the process is characterized in that the hydrocarbon-containing liquid input stream is admixed with a polymerization inhibitor. This allows the polymerization tendency to be yet further reduced, with the result that the feeding to the evaporation apparatus is facilitated since no precipitation of solids occurs.

In a twelfth aspect of the invention, the process is characterized in that the first temperature and the partial evaporation conditions are selected such that the liquid residual stream is between 1% and 20% by weight, preferably between 1% and 10% by weight, most preferably between 1% and 5% by weight, of the hydrocarbon-containing liquid input stream. Investigations have shown that for most impurities this ensures that said impurities remain in the liquid phase and are evaporated only to a small extent, if at all. This makes it possible to ensure trouble-free operation of the POX process over a longer period.

In a thirteenth aspect of the invention, the process is characterized in that the mass flow of the heated first gas input substream stream introduced into the evaporation apparatus is selected such that a temperature of the gaseous mixed input stream discharged from the evaporation apparatus of at most 470° C. is not exceeded. Investigations show that this makes it possible to efficaciously avoid undesired cracking or polymerization reactions of the compounds deriving from the liquid input stream. This makes it possible to ensure trouble-free operation of the POX process over a longer period.

In a fourteenth aspect of the invention, the process is characterized in that the evaporation apparatus is configured as an evaporation column comprising the following constituents:
a shell tube which is arranged upright relative to the vertical,
at least one mass transfer zone arranged within the shell tube, containing at least one mass transfer element, selected from the group of: separating trays, random packing, structured packing,
an inlet for the heated first gas input substream stream arranged below the at least one mass transfer zone,
an inlet for the liquid input stream arranged above the at least one mass transfer zone,
an outlet for the gaseous mixed input stream arranged above the at least one mass transfer zone,
an outlet for the liquid residual stream arranged below the at least one mass transfer zone,
   wherein the evaporation apparatus is further configured to allow mass transfer and direct heat exchange between the heated first gas input substream stream and the liquid input stream.

This configuration of the evaporation apparatus makes it possible to achieve a particularly effective and space-saving evaporation of the liquid phase containing impurities.

In a sixteenth aspect of the invention, the plant is characterized in that the second gas input substream stream is introduced into the partial oxidation reactor via the at least one partial oxidation burner and in that the gaseous mixed input stream is introduced into the partial oxidation reactor via the at least one partial oxidation burner and/or via a separate conduit. The advantages of this aspect of the invention correspond to those discussed in connection with the second aspect of the invention.

In a seventeenth aspect of the invention, the plant is characterized in that the evaporation apparatus is configured as an evaporation column comprising the following constituents:
a shell tube which is arranged upright relative to the vertical,
at least one mass transfer zone arranged within the shell tube, containing at least one mass transfer element, selected from the group of: separating trays, random packing, structured packing,
an inlet for the heated first gas input substream stream arranged below the at least one mass transfer zone,
an inlet for the liquid input stream arranged above the at least one mass transfer zone,
an outlet for the gaseous mixed input stream arranged above the at least one mass transfer zone,
an outlet for the liquid residual stream arranged below the at least one mass transfer zone,
   wherein the evaporation apparatus is further configured to allow mass transfer and direct heat exchange between the heated first gas input substream stream and the liquid input stream.

The advantages of this aspect of the invention correspond to those discussed in connection with the fourteenth aspect of the invention.

### BRIEF DESCRIPTION OF THE DRAWINGS

Developments, advantages and possible applications of the invention are also apparent from the following description of exemplary embodiments and the drawing.

The invention is formed by all of the features described and/or depicted, either on their own or in any combination, irrespective of the way they are combined in the claims or the dependency references therein.

In the figures:

FIG. 1 shows a process flow diagram/a plant according to the prior art,

FIG. 2 shows a first detail view of a process flow diagram/a plant according to one embodiment of the invention,

FIG. 3 shows a second detail view of a process flow diagram/a plant according to one embodiment of the invention.

In the following, “not shown” is to be understood as meaning that an element in the described figure is not shown graphically but is nevertheless present according to the description.

### DETAILED DESCRIPTION OF THE PREFERRED EMBODIMENTS

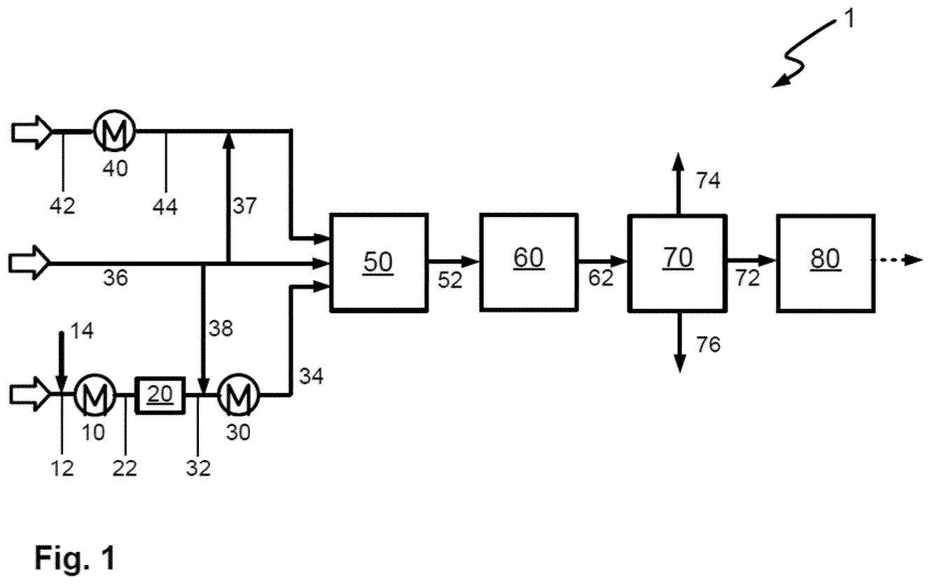

FIG. 1 shows a process flow diagram/a plant for producing a raw synthesis gas by partial oxidation of hydrocarbon-containing gases and liquids according to the prior art. Via a conduit 12, a hydrocarbon-containing gas input stream, in one example natural gas, is introduced into the process/into the plant and supplied to a heating stage 10. A hydrogen-containing gas stream may optionally be introduced into the process/into the plant with the hydrocarbon-containing gas input stream via a conduit 14.

The hydrocarbon-containing gas input stream heated to a temperature of 200° C. to 350° C. in one example is discharged from the heating stage 10 via a conduit 22 and introduced into an optional desulfurization stage 20. The optional desulfurization stage 20 depletes the hydrocarbon-containing gas input stream of sulfur compounds in a manner known per se to those skilled in the art.

The hydrocarbon-containing gas input stream depleted in sulfur compounds is discharged from the desulfurization stage 20 via a conduit 32 and introduced into a heating stage 30. In the heating stage 30, the hydrocarbon-containing gas input stream depleted in sulfur compounds is heated further and then introduced into a partial oxidation reactor 50 via a conduit 34. In one example, the partial oxidation reactor 50 is configured as a POX reactor. In a further example, the partial oxidation reactor 50 is configured as an ATR.

The oxygen-containing oxidant stream oxygen required for the partial oxidation in the partial oxidation reactor 50 is introduced into the process/into the plant via a conduit 42, heated using a heating stage 40 and introduced into the partial oxidation reactor 50 using a conduit 44. In one example, the oxidant stream comprises technical-purity oxygen. In one example, the oxidant stream comprises air. In one example, the oxidant stream comprises oxygen-enriched air.

Via a conduit 36, a moderator stream comprising steam and/or carbon dioxide is introduced into the partial oxidation reactor 50 after optional heating (not shown). In one example, a portion of the moderator stream is diverted via a conduit 37 and admixed with the oxygen-containing oxidant stream for dilution, mixing and/or fine temperature control. In a further example, a portion of the moderator stream is diverted via a conduit 38 and admixed with the hydrocarbon-containing gas input stream for dilution, mixing and/or fine temperature control.

The partial oxidation reactor is configured as a noncatalytic partial oxidation reactor (POX reactor) or as an autothermal reformer (ATR), wherein the POX reactor or the autothermal reformer comprises at least one partial oxidation burner. The partial oxidation reactor effects reaction of the gas input stream with the oxygen-containing oxidant stream and the optional moderator stream under conditions of noncatalytic partial oxidation (POX) or of autothermal reforming (ATR) to afford a hot raw synthesis gas stream.

The hot raw synthesis gas stream is discharged from the partial oxidation reactor via a conduit 52 and fed into a gas cooling stage 60. In the gas cooling stage 60, which in examples may be configured as heat exchangers or waste heat boilers, the hot raw synthesis gas is cooled to a temperature which allows subsequent removal of acidic, undesired gas constituents.

Via a conduit 62, the cooled raw synthesis gas stream is discharged from the gas cooling stage 60 and supplied to a synthesis gas deacidification stage 70 in which especially acid gas constituents such as carbon dioxide CO₂ and/or gaseous sulfur compounds, especially hydrogen sulfide H₂S, are separated. In one example, the synthesis gas deacidification stage 70 operates according to a physisorptive gas scrubbing process with cryogenic methanol as an absorbent/scrubbing medium (Rectisol process). In a further example, the synthesis gas deacidification stage 70 operates according to a chemisorptive gas scrubbing process with an amine-containing absorbent/scrubbing medium. The process conditions of the physisorptive/chemisorptive gas scrubbing process are known per se to those skilled in the art. It is advantageous when acidic gas constituents such as carbon dioxide and/or gaseous sulfur compounds are obtained separately in the regeneration of the scrubbing medium and discharged from the process/the plant via separate conduits. In the example shown in FIG. 1, carbon dioxide is discharged via a conduit 74 and gaseous sulfur compounds are discharged via a conduit 76.

In the example shown in FIG. 1, the raw synthesis gas stream depleted in acidic gas constituents is discharged from the synthesis gas deacidification stage 70 via a conduit 72 and then supplied to a synthesis gas conditioning stage 80. The synthesis gas conditioning stage is exemplary for further physicochemical conditioning steps which depend on the type of intended further use of the synthesis gas. Examples of further conditioning steps are temperature elevation or reduction, pressure elevation or reduction, alteration of chemical composition, for example through removal of secondary components or impurities, for example via adsorption processes, for example by pressure swing adsorption (PSA). Depending on the type of conditioning steps performed, this affords one or more synthesis gas products which are discharged from the synthesis gas conditioning stage 80 as indicated by a dashed arrow.

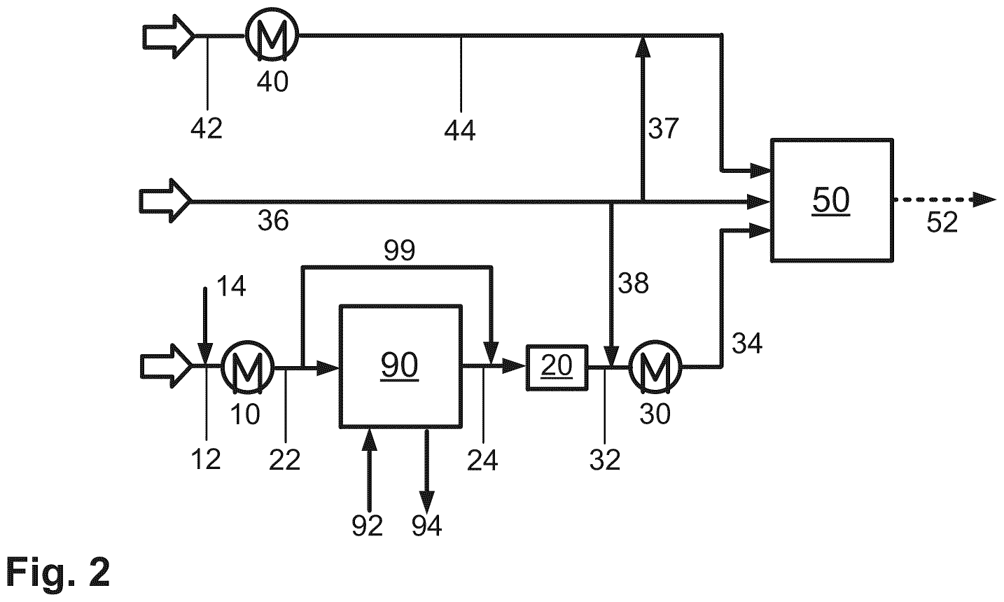

FIG. 2 shows a first detail view of a process flow diagram/a plant according to one embodiment of the invention. Identical reference numerals in the figures correspond to identical process step/plant constituents and identical process conditions, unless otherwise stated in the individual context. The other process steps/plant constituents not shown in FIG. 1 correspond to those in FIG. 1.

In contrast to FIG. 1, in the inventive example shown in FIG. 2, the heated, hydrocarbon-containing gas input stream in conduit 22 is divided into a first heated gas input substream stream and into a second heated gas input substream stream. The first heated gas input substream stream is introduced into an evaporation apparatus 90 via conduit 22 and there brought into intensive contact with a liquid input stream which is introduced into the evaporation apparatus 90 via conduit 92. The first heated gas input substream provides the heat of evaporation. Furthermore, the hydrocarbons in the first heated gas input substream stream reduce the partial pressure of the evaporated components of the liquid input stream, thus reducing the tendency to interactions of the partial evaporated liquid input stream. The partial evaporation conditions are selected here such that a gaseous mixed input stream is discharged from the evaporation apparatus via a conduit 24 and a liquid residual stream is discharged from the evaporation apparatus via a conduit 94, wherein the gaseous mixed input stream is depleted in the impurities relative to the hydrocarbon-containing liquid input stream and wherein the liquid residual stream is enriched in the impurities relative to the hydrocarbon-containing liquid input stream.

The gaseous mixed input stream is discharged from the evaporation apparatus 90 via conduit 24. The second heated gas input substream stream is bypassed around the evaporation apparatus 90 via a conduit 99 and admixed with the gaseous mixed input stream in conduit 24. The resulting combined gaseous mixed input stream is supplied to the optional desulfurization stage 20 via conduit 24. The further process steps/plant constituents correspond to those described in connection with FIG. 1.

In an alternative example not shown in FIG. 2, the entire gaseous hydrocarbon stream is introduced into the desulfurization stage 20 and divided into two substreams only downstream thereof, one substream being passed to the evaporation apparatus 90 as a heat transfer medium and the other substream being directly supplied to the partial oxidation reactor 50.

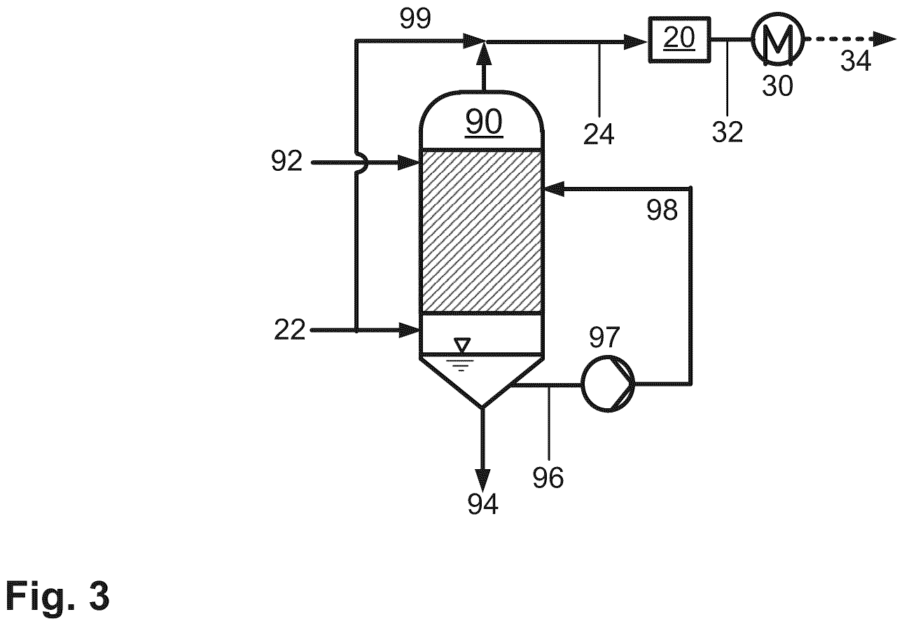

FIG. 3 shows a second detail view of a process flow diagram/a plant according to one embodiment of the invention and therein an example of the configuration of the evaporation apparatus 90. Identical reference numerals in the figures correspond to identical process step/plant constituents and identical process conditions, unless otherwise stated in the individual context. The other process steps/plant constituents not shown in FIG. 1 correspond to those in FIG. 1.

The liquid input stream for partial evaporation is introduced into the evaporation apparatus 90 via conduit 92 in the upper portion thereof and trickles downwards over the surface area-enlarging internals (shown shaded in FIG. 3) such as for example bubble cap trays, sieve trays, structured packings, random packings or any desired combination of two or more of the recited elements.

The first heated gas input substream stream is introduced into the evaporation apparatus 90 at the lower end thereof and passes through the evaporation apparatus in countercurrent to the liquid input stream. This involves intensive mass transfer and heat exchange between the two fluid streams and a portion of the liquid input stream is evaporated to obtain a gaseous mixed input stream. The partial evaporation conditions are selected here such that a gaseous mixed input stream is discharged from the evaporation apparatus via a conduit 24 and a liquid residual stream is discharged from the evaporation apparatus via a conduit 94, wherein the gaseous mixed input stream is depleted in the impurities relative to the hydrocarbon-containing liquid input stream and wherein the liquid residual stream is enriched in the impurities relative to the hydrocarbon-containing liquid input stream.

The gaseous mixed input stream is discharged from the evaporation apparatus 90 via conduit 24. The second heated gas input substream stream is bypassed around the evaporation apparatus 90 via a conduit 99 and admixed with the gaseous mixed input stream in conduit 24. The resulting combined gaseous mixed input stream is supplied to the optional desulfurization stage 20 via conduit 24. The further process steps/plant constituents correspond to those described in connection with FIG. 1.

To avoid undesired liquid outflows, demisting apparatuses may in one example be mounted at the top of the evaporation apparatus 90. In a further example, the gas inlet into the evaporation apparatus may be in the form of an immersed tube which is immersed in the reservoir of liquid hydrocarbons collected in the lower portion of the evaporation apparatus as indicated in FIG. 3.

To adjust the flow conditions during mass transfer and heat exchange in the evaporation apparatus, in one example, in the manner shown in FIG. 3, a portion of the reservoir of liquid hydrocarbons collected in the lower portion of the evaporation apparatus may be discharged via a conduit 96 and a pump 97 and recycled into the upper portion of the evaporation apparatus, preferably above the surface area-enlarging internals, via a conduit 98. The remaining proportion of the reservoir of liquid hydrocarbons collected in the lower portion of the evaporation apparatus is discharged from the evaporation apparatus via a conduit 94 and is in one example supplied to a further treatment or the recovery of constituents present, for example of metal constituents.

Changes to the above-described embodiments of the present disclosure are possible without departing from the scope of the present disclosure defined by the accompanying claims. Expressions such as “including”, “comprising”, “containing”, “have”, “is” which are used for describing and claiming the present disclosure shall be understood to be nonexhaustive, i.e. they allow for the presence of articles, components or elements that are not explicitly described. References to the singular are to be understood as also referring to the plural in the absence of explicit indications to the contrary in the particular case.

### LIST OF REFERENCE NUMERALS

1 Process/plant
10 Heating stage
12 Conduit
14 Conduit
20 Desulfurization stage
22 Conduit
24 Conduit
30 Heating stage
32 Conduit
34 Conduit
36 Conduit
37 Conduit
38 Conduit
40 Heating stage
42 Conduit
44 Conduit
50 Partial oxidation reactor (POX, ATR)
52 Conduit
60 Gas cooling stage
62 Conduit
70 Synthesis gas deacidification stage
72 Conduit
74 Conduit
76 Conduit
80 Synthesis gas conditioning stage
90 Evaporation stage
92 Conduit
94 Conduit
96 Conduit
97 Pump
98 Conduit
99 Conduit

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

1. A process for producing a raw synthesis gas containing hydrogen and carbon oxides by simultaneous partial oxidation of a hydrocarbon-containing gas input stream and a hydrocarbon-containing liquid input stream comprising:
(a) providing the hydrocarbon-containing gas input stream and heating the hydrocarbon-containing gas input stream;
(b) providing the hydrocarbon-containing liquid input stream comprising hydrocarbons as the primary constituent fraction and at least one impurity fraction containing impurities, wherein the primary constituent fraction has a first average boiling point and wherein the at least one impurity fraction has a second average boiling point, wherein the second average boiling point is greater than the first average boiling point;
(c) dividing the heated hydrocarbon-containing gas input stream into a first gas input substream stream and into a second gas input substream stream;
(d) introducing the heated first gas input substream stream and the liquid input stream into an evaporation apparatus, contacting the heated first gas input substream stream and the liquid input stream in the evaporation apparatus under partial evaporation conditions, wherein the partial evaporation conditions are selected such that a gaseous mixed input stream and a liquid residual stream are discharged from the evaporation apparatus, wherein the gaseous mixed input stream is depleted in the impurities relative to the hydrocarbon-containing liquid input stream and wherein the liquid residual stream is enriched in the impurities relative to the hydrocarbon-containing liquid input stream;
(e) introducing the gaseous mixed input stream and the second gas input substream stream into a partial oxidation reactor which is configured as a noncatalytic partial oxidation reactor or as an autothermal reformer, wherein the noncatalytic partial oxidation reactor or the autothermal reformer comprise at least one partial oxidation burner, reacting the gaseous mixed input stream and the second gas input substream stream with an oxygen-containing oxidant stream and an optional moderator stream comprising steam and/or carbon dioxide in the partial oxidation reactor under conditions of noncatalytic partial oxidation or of autothermal reforming to afford a raw synthesis gas stream;
(f) discharging the raw synthesis gas stream from the noncatalytic partial oxidation reactor and supplying the raw synthesis gas stream to at least one further purification, treatment, conditioning and/or processing step.

2. The process according to claim 1, wherein the second gas input substream stream is introduced into the partial oxidation reactor via the at least one partial oxidation burner and in that the gaseous mixed input stream is introduced into the partial oxidation reactor via the at least one partial oxidation burner and/or via a separate conduit.

3. The process according to claim 1, wherein the first average boiling point and the second average boiling point differ by at least 20° C.

4. The process according to claim 1, wherein the at least one impurity fraction comprises inorganic or organometallic constituents.

5. The process according to claim 4, wherein the at least one impurity fraction comprises inorganic constituents dissolved and/or suspended in the primary constituent fraction.

6. The process according to claim 5, wherein the inorganic constituents are present in ionic form, comprising the presence of at least one cation selected from the group of: Na, K, Mg, Ca, Al, Si, Fe, Co, Cr, Mn, Zn, and/or comprising the presence of at least one anion selected from the group of: phosphates, sulfates, chlorides, nitrates.

7. The process according to claim 6, wherein the hydrocarbon-containing liquid input stream is admixed with a complexing agent which prevents or reduces crystallization of one or more of the ionic constituents.

8. The process according to claim 4, wherein the liquid residual stream is supplied to a process for recovery of metals.

9. The process according to claim 1, wherein the at least one impurity fraction comprises liquid hydrocarbons containing functional groups comprising heteroatoms such as oxygen, nitrogen and sulfur, preferably alcohols, aldehydes, ketones, acids or ethers.

10. The process according to claim 1, wherein the at least one impurity fraction comprises polymerizable liquid hydrocarbons.

11. The process according to claim 10, wherein the hydrocarbon-containing liquid input stream is admixed with a polymerization inhibitor.

12. The process according to claim 1, wherein the first temperature and the partial evaporation conditions are selected such that the liquid residual stream is between 1% and 20% by weight of the hydrocarbon-containing liquid input stream.

13. The process according to claim 1, wherein the mass flow of the heated first gas input substream stream introduced into the evaporation apparatus is selected such that a temperature of the gaseous mixed input stream discharged from the evaporation apparatus of at most 470° C. is not exceeded.

14. The process according to claim 1, wherein the evaporation apparatus is configured as an evaporation column comprising the following constituents:
a shell tube which is arranged upright relative to the vertical,
at least one mass transfer zone arranged within the shell tube, containing at least one mass transfer element, selected from the group of: separating trays, random packing, structured packing,
an inlet for the heated first gas input substream stream arranged below the at least one mass transfer zone,
an inlet for the liquid input stream arranged above the at least one mass transfer zone,
an outlet for the gaseous mixed input stream arranged above the at least one mass transfer zone,
an outlet for the liquid residual stream arranged below the at least one mass transfer zone,
wherein the evaporation apparatus is further configured to allow mass transfer and direct heat exchange between the heated first gas input substream stream and the liquid input stream.

15. A plant for producing a raw synthesis gas containing hydrogen and carbon oxides by simultaneous partial oxidation of a hydrocarbon-containing gas input stream and a hydrocarbon-containing liquid input stream comprising the following constituents in fluid connection with one another:
(a) a means for providing the hydrocarbon-containing gas input stream, preferably natural gas, and a means for heating the hydrocarbon-containing gas input stream;
(b) a means for providing the hydrocarbon-containing liquid input stream comprising hydrocarbons as the primary constituent fraction and at least one impurity fraction containing impurities, wherein the primary constituent fraction has a first average boiling point and wherein the at least one impurity fraction has a second average boiling point, wherein the second average boiling point is greater than the first average boiling point;
(c) a means for dividing the heated hydrocarbon-containing gas input stream into a first gas input substream stream and into a second gas input substream stream;
(d) an evaporation apparatus suitable for contacting the heated first gas input substream stream and the liquid input stream in the evaporation apparatus under partial evaporation conditions, wherein the partial evaporation conditions are selected such that a gaseous mixed input stream and a liquid residual stream are discharged from the evaporation apparatus, wherein the gaseous mixed input stream is depleted in the impurities relative to the hydrocarbon-containing liquid input stream and wherein the liquid residual stream is enriched in the impurities relative to the hydrocarbon-containing liquid input stream, means for introducing the heated first gas input substream stream and the liquid input stream into the evaporation apparatus;
(e) a partial oxidation reactor which is configured as a noncatalytic partial oxidation reactor or as an autothermal reformer, wherein the noncatalytic partial oxidation reactor or the autothermal reformer comprise at least one partial oxidation burner, a means for introducing the gaseous mixed input stream and the second gas input substream stream into the partial oxidation reactor;
(f) a means for discharging the raw synthesis gas stream from the partial oxidation reactor and means for supplying the raw synthesis gas stream to at least one further purification, treatment, conditioning and/or processing step.

16. The plant according to claim 15, configured such that the second gas input substream stream is introduced into the partial oxidation reactor via the at least one partial oxidation burner and that the gaseous mixed input stream is introduced into the partial oxidation reactor via the at least one partial oxidation burner and/or via a separate conduit.

17. The plant according to claim 15, wherein the evaporation apparatus is configured as an evaporation column comprising the following constituents:
a shell tube which is arranged upright relative to the vertical,
at least one mass transfer zone arranged within the shell tube, containing at least one mass transfer element, selected from the group of: separating trays, random packing, structured packing,
an inlet for the heated first gas input substream stream arranged below the at least one mass transfer zone,
an inlet for the liquid input stream arranged above the at least one mass transfer zone,
an outlet for the gaseous mixed input stream arranged above the at least one mass transfer zone,
an outlet for the liquid residual stream arranged below the at least one mass transfer zone,
wherein the evaporation apparatus is further configured to allow mass transfer and direct heat exchange between the heated first gas input substream stream and the liquid input stream.
